(19) United States
(12) Patent Application Publication
(10) Pub. No.: US 2018/0075609 A1
(43) Pub. Date: Mar. 15, 2018

(54) Method of Estimating Relative Motion Using a Visual-Inertial Sensor

(71) Applicant: DunAn Precision, Inc., Dallas, TX (US)

(72) Inventor: Hongsheng He, Austin, TX (US)

(21) Appl. No.: 15/701,488

(22) Filed: Sep. 12, 2017

Related U.S. Application Data
(60) Provisional application No. 62/393,338, filed on Sep. 12, 2016.
(60) Provisional application No. 62/403,230, filed on Oct. 3, 2016.

(51) Int. Cl. G06T 7/20; G06T 7/70

(52) U.S. Cl. CPC G06T 7/20; G06T 7/70

(57) ABSTRACT

A method of determining translational motion of a moving object within a field of view of a camera includes: providing an imaging device oriented to capture a moving object within a field of view from a point of view of the device; accelerating the central point of the imaging device around a line of sight; processing visual data from the imaging device on a processing unit to determine a visual optical flow or feature flow in the field of view of the device; measuring an acceleration of the camera around the line of sight; and determining a translational velocity of a moving object within the field of view of the imaging device based on the determined visual optical flow of the field of view and measured acceleration of the point of view of the imaging device.

### CROSS-REFERENCES TO RELATED APPLICATIONS

This application claims priority to U.S. Provisional Patent Application Ser. No. 62/393,338 for a “Method of Estimating Relative Motion Using a Visual-Inertial Sensor” filed on Sep. 12, 2016, and U.S. Provisional Patent Application Ser. No. 62/403,230 for a “Method of Depth Estimation Using a Camera and Inertial Sensor” filed on Oct. 3, 2016, the contents of which are incorporated herein by reference in its entirety.

### FIELD

This disclosure relates to measuring and determining velocities of a moving body within a field of view of a camera.

### BACKGROUND

Motion estimation of a moving object is a fundamental problem in robotic and assistive applications. Increasing robotic applications require a robot to work in complex and dynamic environments with limited prior knowledge. In these circumstances, it is of vital importance for a robot to be able to estimate relative motion of moving objects with respect to the robot. Motion estimation allows a robot to perceive surrounding dynamics and avoid potential motion collisions in an unknown complex environment.

Motion estimation using a camera is an ill-posed problem as the motion is generally in 3D space whereas an image is the projection of the 3D scene onto the 2D plane. In theory, translational velocities can only be recovered up to a scale from visual optical flow, owing to the coupling between translational motion and scene depth in optical flow. An example of optical flow observed by a visual-inertial sensing unit is shown in FIG. 1. The optical flow on background regions (e.g. the still building) was resulted by the camera's motion and the optical flow on the moving objects (e.g. cars) was caused by the relative motion between the camera and the objects.

The problem of camera motion estimation has been extensively studied. With the assumption of sufficient static visual features in the environment, the rotational motion and the direction of the translational motion of the camera can be obtained from feature tracking based on different constraints. Another research problem that is closely related to this invention is simultaneous localization and mapping (SLAM), which tracks the movement of the camera and reconstruct the static/dynamic environment. Though these methods allow environmental motion to certain extent, they cannot be directly applied to estimate relative motion, where environmental motion also plays a major part.

What is needed, therefore, is a method and system for estimating motion of a moving object from visual optical flow that is observed by a moving visual-inertial sensing unit.

### SUMMARY

The above and other needs are met by a method of determining translational motion of a moving object within a field of view of a camera, the method including: providing an imaging device oriented to capture a moving object within a field of view from a point of view of the device; accelerating the central point of the imaging device around a line of sight; processing visual data from the imaging device on a processing unit to determine a visual optical flow or feature flow in the field of view of the device; measuring an acceleration of the camera around the line of sight; and determining a translational velocity of a moving object within the field of view of the imaging device based on the determined visual optical flow of the field of view and measured acceleration of the point of view of the imaging device.

In one embodiment, the method further includes measuring the acceleration of the imaging device around the line of sight with an inertial measurement unit associated with the imaging device. In another embodiment, the central point of the imaging device is accelerated on a turntable such that the imaging device is accelerated around the central point of the imaging device.

In yet another embodiment, the imaging device comprises a plurality of cameras located around the line of sight, and wherein the central point of the imaging device is accelerated by sequentially capturing an image on each of the plurality of cameras.

In one embodiment, a translation velocity of a fixed object in the field of view of the camera is assumed to be constant.

In a second aspect, a method of determining translational motion of a moving object within a field of view of a camera includes determining a visual feature flow of a scene captured on a visual sensor; applying a bilinear constraint to the visual feature flow captured on the visual sensor to determine a relative rotational velocity of the visual sensor; measuring dynamics of the visual sensor with an inertial sensor associated with the visual sensor; applying a dynamics constraint based on visual sensor dynamics measured with the inertial sensor, visual feature flow from the visual sensor, and the determined relative rotational velocity of the visual sensor; and determining a relative translational velocity of an object moving within a field of view of the visual sensor based on the applied dynamics constraint.

In one embodiment, the translational velocity of the object moving within the field of view of the visual sensor is assumed to be constant. In another embodiment, the method further includes applying a filter to refine the determined relative translational velocity of the object, the filter including: selecting a random subset of optical flow points captured by the visual sensor; initially estimating the relative translational velocity, rotational velocity, and relative depth estimation of the random subset of optical flow points within the field of view based on feature flow and measured visual sensor dynamics; and iteratively updating each of the estimated translational velocity, rotational velocity, and relative depth estimations.

In one embodiment, the method further includes applying a Kalman filter to the estimated velocities of the random subset of optical flow points captured by the visual sensor. In another embodiment, the method further includes repeating the iterative updating of each of the estimated velocities until an accuracy of the estimated velocities is within a predetermined threshold. In yet another embodiment, the method further includes selecting a random subset of optical flow points captured by the optical sensor until a majority of optical flow points of the field of view have been selected.

In one embodiment, the relative translational velocity is determined based on a relationship between feature flow, relative rotational velocity, relative translational velocity, a location of pixels within the field of view of the visual sensor, acceleration of the visual sensor, and scene depth.

In a third aspect, a system for estimating a velocity of an object includes: a visual sensor for capturing image data including an object within a field of view; an inertial measurement unit associated with the visual sensor for measuring and outputting dynamics data of the visual sensor; a processor in electronic communication with the visual sensor and the inertial measurement unit, the processor configured to determine one of an optical visual flow and feature flow of the field view of the visual sensor; determine an acceleration of the visual sensor around a line of sight based on dynamics data received from the inertial measurement unit; estimate a translational velocity of the object within the field of view of the visual sensor based on the determined optical visual flow and feature flow and determined acceleration of the visual sensor around the line of sight of the visual sensor.

In one embodiment, the visual sensor comprises an array of cameras concentrically located around a line of sight. In another embodiment, the visual sensor further including a turntable for accelerating the visual sensor around a line of sight.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several view, and wherein:

FIG. 1 shows a field of view of an imaging device including feature flow according to one embodiment of the present disclosure;

FIG. 2 shows projection of a moving object on an image plane is modeled using a pinhole model according to one embodiment of the present disclosure;

FIG. 3 shows acceleration of a visual sensor around a line of sight according to one embodiment of the present disclosure;

FIG. 4 shows an array of visual sensors according to one embodiment of the present disclosure;

FIG. 5 shows a plot of trajectories of estimated translational motion according to one embodiment of the present disclosure;

FIG. 6 shows trajectories of estimated rotational motion according to one embodiment of the present disclosure;

FIG. 7 shows a process of determining relative translational velocity using visual and inertial sensors according to one embodiment of the present disclosure;

FIG. 8 shows a plot of motion of a camera and an object within a field of view of the camera according to one embodiment of the present disclosure;

FIG. 9 shows a plot comparing the estimation translational motion of an object and tracked motion;

FIG. 10 shows a plot of tracking errors in comparing estimated translation motion and tracked motion according to one embodiment of the present disclosure;

FIG. 11 shows a plot of tracking errors in comparing estimated translation motion and tracked motion according to one embodiment of the present disclosure;

FIG. 12 shows a plot of tracking errors in comparing estimated translation motion and tracked motion according to one embodiment of the present disclosure;

FIG. 13 shows a flowchart of iterative optimization of estimated velocities of an object within a field of view of the visual sensor according to one embodiment of the present disclosure; and

FIG. 14 shows a system including a visual sensor, inertial sensor, and processor according to one embodiment of the present disclosure.

### DETAILED DESCRIPTION

Various terms used herein are intended to have particular meanings. Some of these terms are defined below for the purpose of clarity. The definitions given below are meant to cover all forms of the words being defined (e.g., singular, plural, present tense, past tense). If the definition of any term below diverges from the commonly understood and/or dictionary definition of such term, the definitions below control.

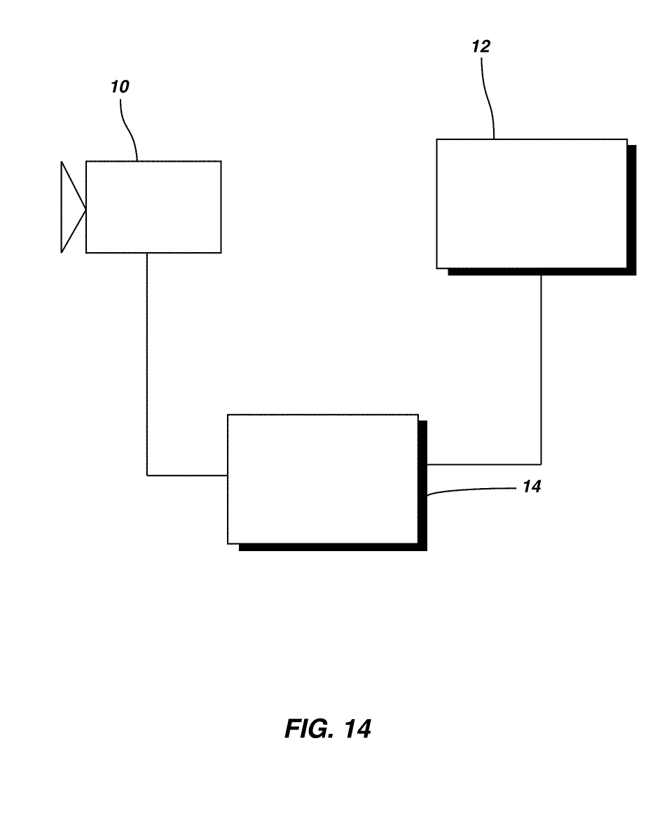

A system and method of estimating relative motion using a visual-inertial sensor is provided for measuring a relative motion of a moving rigid body using a visual-inertial sensing unit. The system and method determine real-scale relative translational motion and rotational motion, thereby allowing a typical camera to detect a velocity of an object. The system includes a camera 10 (FIG. 14), such as a video camera, digital camera, or other suitable camera, and an inertial measurement unit or inertial sensor 12 (“IMU”). The IMU 12 is associated with the camera 10 such that movement of the camera 10 is detected by the IMU 12. For example, the IMU 12 and camera 10 may be co-located within a housing or other structure. A processor 14 in communication with the camera 10 and IMU 12 determines a translational velocity of a moving object within a field of view of the camera based on data received from the camera 10 and the IMU 12. As referred to herein, a field of view is defined according to its ordinary meaning, and includes an area that is captured by the camera 10.

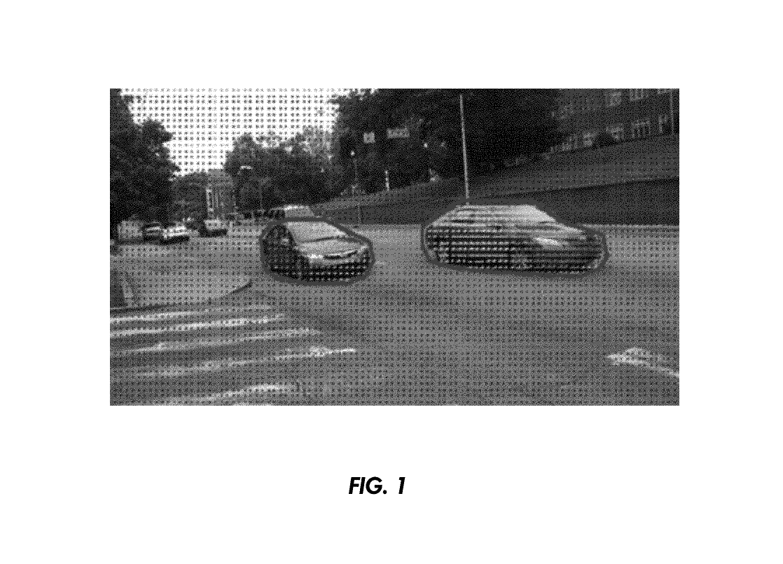

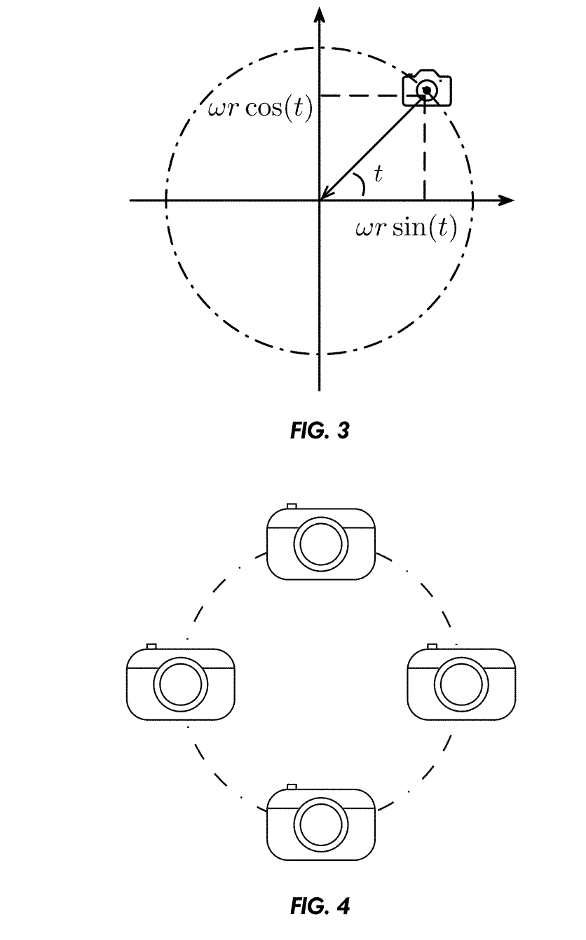

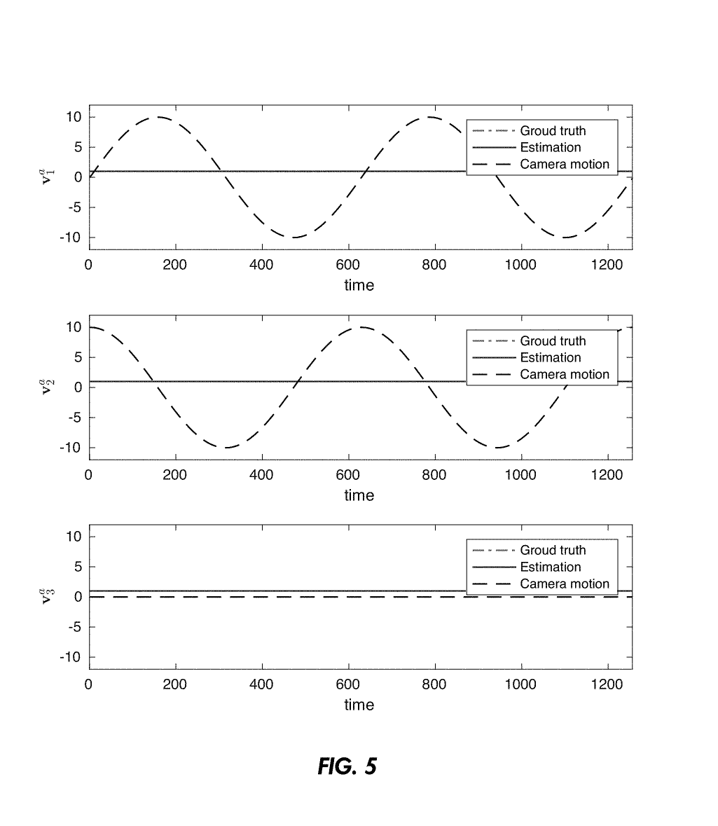

To determine a translational velocity of an object within a field of view of the camera 10, visual data from the camera 10 is analyzed on the processor 14 to determine motion within the field of view of the camera 10. For example, field of view data of the camera 10 may be analyzed to determine an optical or visual flow of a field of view of the camera 10, as shown in FIG. 1. The camera 10 is then accelerated and acceleration of the camera 10 is measured by the IMU 12. For example, the camera 10 may be physically accelerated around a central point, such as by placing the camera 10 on a turntable 16 or other mechanical mechanism for accelerating the camera 10 (FIG. 3). The IMU 12 associated with the camera may measure a physical acceleration of the camera 10. Alternatively, as shown in FIG. 4, an array of cameras 18 may be positioned around a line of sight and an acceleration of a point of view of the cameras determined based on sequentially capturing a field of view of each camera of the array and using a known location of each camera of the array.

The processor 14 in communication with the camera 10 and inertial measurement unit 12 determines a magnitude of a translational velocity of an object within the field of view of the camera 10 based on optical data captured by the camera and measured acceleration of the camera 10 by the IMU 12. Algorithms executed on the processor determine a translational velocity of an object based on data from the camera 10 and inertial measurement unit 12, as discussed in greater detail below.

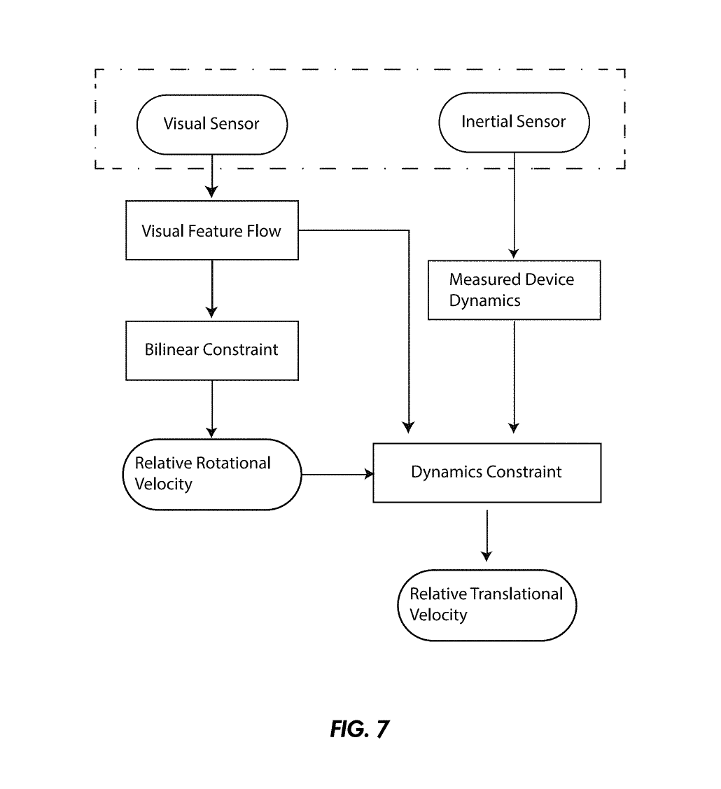

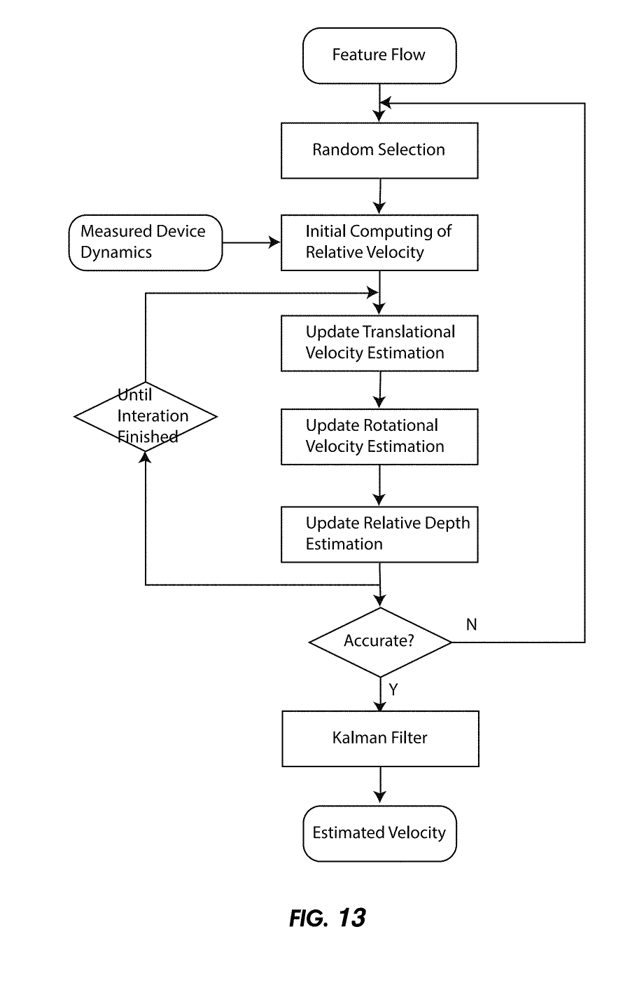

Referring to the flowchart FIG. 7, a visual feature flow of a field of view is analyzed from an imaging sensor of the camera 10, such as from the camera 10 or other optical-flow measuring device. Relative rotational velocities of an object within the field of view may be determined based on visual data from the camera 10. Simultaneously, motion data from the IMU 12 is detected to measure dynamics of the camera 10. A relative rotational velocity and measured dynamics are analyzed using a dynamics constraint to provide a relative translational velocity of an object within the field of view of the camera 12. Referring to FIG. 13, one or more filters may be applied to further refine an estimated relative velocity of an object within the field of view of the camera 10.

Challenges include decoupling translational motion and scene depth in optical-flow observations to measure the absolute magnitude of translational motion. Scene depth is not directly related to dynamics of the camera 10, which is measured by the associated IMU 12, and therefore an additional constraint is required to model the relation. A second challenge is to resolve the camera's and the object's motion. The IMU 12 is associated with the camera 10 instead of moving objects such that the motion of an object cannot be estimated solely from visual observations, which result from both the camera's and the object's motion. A third challenge is to handle measurement noise and outliers in long-term motion tracking. Inertial measurement suffers from noise and accumulated errors, and optical flow generally comes with outliers due to the inaccuracy of feature matching.

Motion of a moving object is measured from visual optical flow that may be observed by a moving camera 10 and associated IMU 12. Visual and inertial sensor hardware operating independently are common in most robotic platforms and wearable devices. Inertial sensors can precisely measure short-term ego motion, while visual sensors can sense environmental dynamics. With their complementary properties, visual and inertial sensors form a minimal sensing system to measure relative motion. Resolving a magnitude of translational motion is accomplished by decoupling translational velocities and scene depth using inertial sensors, and handling measurement noise and outliers during long-time motion tracking using a motion model. The problem of motion estimation is formulated in an optimization framework of visual optical flow associated with inertial measurements. Rotational velocities of an object are determined based on a bilinear constraint, and translational velocity is estimated based on a proposed dynamics constraint, which shows the relationship between scene depth and the scale of translational motion. To suppress noise in optical-flow observations, an iterative optimization mechanism is applied that improves overall estimation accuracy. The motion of rigid-body objects is modeled as a general discrete-time stochastic nonlinear system, and jerk noise and observation noise are smoothed out using an extended Kalman filter.

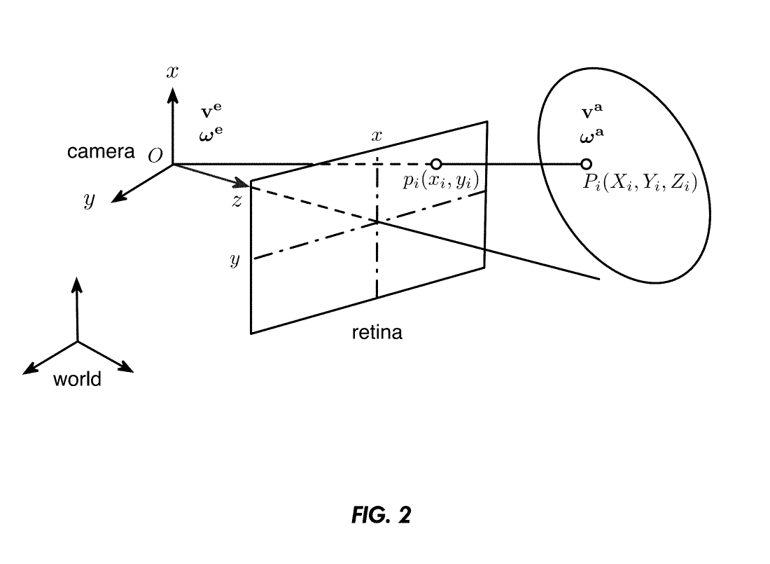

Projection of a moving object on an image plane is modeled using a pinhole model, as shown in FIG. 2, and dynamics of the camera 10 include rotational velocities and acceleration are measured by the IMU 12. The inertial measurement unit (IMU) 12 typically outputs three-axis linear acceleration and three-axis rotation motion of the device. A spatial configuration of the camera 10 and the IMU 12 is assumed to be fixed, and their relative position is determined by online or offline calibration. Measurements from the camera 10 and IMU 12 are synchronized in space and in time.

Motion of an object projection in the image plane is computed in terms of optical flow or feature flow. Instantaneous velocities of a feature point in the field of view of the camera 10 is determined by relative velocities and positions between the camera 10 and the observed object. The relative velocities include relative rotational velocities and translational velocities. The position between the camera 10 and the observed object are expressed in the 3-dimensional space with respect to the frame of the camera 10.

Feature flow is directly proportional to relative velocities and inversely proportional to a relative distance between the camera 10 and an observed object. Coefficients of this relationship are pixel positions in an image frame and intrinsic parameters of the camera 10. The disclosed method determines relative velocities between the camera 10 and the moving object from the observed feature flow and measured camera dynamics. The relative velocities are recovered by minimizing the matching errors of observed visual flow and camera dynamics.

The feature flow generated by multiple rigid bodies can be determined and segmented using known computer-vision algorithms. The feature flow of a single object is used to compute the relative velocities of that particular object to the camera 10.

A bilinear constraint is obtained by optimizing the feature flow function with respect to the relative distance. From the bilinear constraint, the relative rotational motion can be fully recovered and only the direction of the translational velocity is computable with sufficient number of feature flow observations. The translational velocities are recovered up to a scale that is related to the relative distance. The bilinear constraint is depth independent so that neither the relative distance and the scale of translational motion can be recovered. The rotational velocity of a rigid object may also be estimated by motion parallax or epiploar constraints.

A solution for the direction of the motion is eigenvectors corresponding to the smallest eigenvalues of the equation composed by bilinear constraints of multiple feature flow points. With the direction of the translational velocity, the rotational velocity can be fully recovered, including the scale and direction, by solving a linear-system equation generated from the bilinear constraint. The rotational velocity ω^{a} can be precisely recovered from the optical flow given measured ego dynamics, while the translational motion can be estimated up to a scale ambiguity using the bilinear constraint.

The twin problem with velocity estimation from feature flow is the recovery of scene depth. An ordinary camera cannot measure scene depth without the aid of an additional device. In the present disclosure, the closed-form solution is disclosed to determine the scale of translational velocities and relative distance by using the measurements from the visual-inertial device.

The optimization function of the dynamics constraint is obtained by computing the derivatives of the function of feature flow oᵢ with respect to time. The dynamics constrain gives the relation between feature flow oᵢ, relative rotational velocity ω^{a}=(ωₓ^{a}, ω_{y}^{a}, ω_{z}^{a}), relative translational velocity v^{a}=(vₓ^{a}, v_{y}^{a}, v_{z}^{a}), pixel positions in the image plane (x₁, yᵢ), the acceleration of the imaging device or camera 10 \dot{v}^{e}, and scene depth Zᵢ, as follows,

$${g}_{a c} ( {v}_{z}^{a} , {Z}_{i} ) = \frac{{v}_{z}^{a}}{{Z}_{i}} ( 2 {o}_{i} - {B}_{i} {ω}^{a} ) + \frac{1}{{Z}_{i}} {A}_{i} {\dot{v}}^{e} + ( {ω}_{x}^{a} \frac{{y}_{i}}{f} - {ω}_{y}^{a} \frac{{x}_{i}}{f} ) ( {o}_{i} - {B}_{i} {ω}^{a} ) + \frac{d}{dt} ( {B}_{i} ) {ω}^{a} + {B}_{i} {ω}^{a} - {\dot{o}}_{i} = 0$$

$$where$$

$${A}_{i} = [ \begin{matrix}- f & 0 & {x}_{i} \\ 0 & - f & {y}_{i}\end{matrix} ]$$

$$and$$

$${B}_{i} = \frac{1}{f} [ \begin{matrix}{x}_{i} {y}_{i} & - ( {f}^{2} + {x}_{i}^{2} ) & {fy}_{i} \\ ( {f}^{2} + {y}_{i}^{2} ) & - {x}_{i} {y}_{i} & - {fx}_{i}\end{matrix} ]$$

$$and$$

$$\frac{d}{dt} ( {B}_{i} ) = \frac{d}{dt} ( \frac{1}{f} [ \begin{matrix}{x}_{i} {y}_{i} & - ( {f}^{2} + {x}_{i}^{2} ) & {fy}_{i} \\ ( {f}^{2} + {y}_{i}^{2} ) & - {x}_{i} {y}_{i} & - {fx}_{i}\end{matrix} ] ) = \frac{1}{f} [ \begin{matrix}{\dot{x}}_{i} {y}_{i} + {x}_{i} {\dot{y}}_{i} & - 2 {x}_{i} {\dot{x}}_{i} & f {\dot{y}}_{i} \\ 2 {y}_{i} {\dot{y}}_{i} & - {\dot{x}}_{i} {y}_{i} - {x}_{i} {\dot{y}}_{i} & - f {\dot{x}}_{i}\end{matrix} ]$$

with f as the focal length of the camera.

With n feature flow observations, there are 2n linear equations of the n+1 unknowns of the relative distance and translational velocities. Therefore, both the scene depth and scale of translational motion can be recovered with a sufficient number of observations.

The method assumes that the motion of the moving rigid body is constant \dot{v}^{a}=0 or with relatively small acceleration \dot{v}^{a}<<\dot{v}^{e} during a short measurement span. Only the translational velocity is assumed to be constant during the measurement, whereas rotational motion may be arbitrary.

In the example as illustrated in FIG. 3, the motion of the camera 12 was rotating around a direction of sight, which can be conveniently implemented in practical applications by attaching the camera to a moving turntable. Alternatively, an array of cameras can be used to simulate the motion of one camera, when the shutters of the camera array are controlled in a sequence, as shown in FIG. 4.

Time of flight Zᵢ/v_{z} can be directly obtained for each observation point. The critical parameter could be used to evaluate the probability of a potential collision with a moving object, playing an important role in robotic and wearable applications.

Feature flow is vulnerable to observation noise and full of outliers due to imprecise motion segmentation especially when motion is overlapped. Therefore, a local refinement mechanism improves accuracy of motion estimation by suppressing the influences of optical-flow outliers. The feature flow model is continuous with respect to both relative rotational and translational velocities. As a result of the continuity, translational and rotational velocities are iteratively optimized from an arbitrary staring direction.

Simulation studies were conducted with a virtual camera having a focal length of 0.0187 m and CCD size 0.01×0.01 m². In the simulation, optical flow was generated using the virtual camera for a region of 30×30 pixels. The scene depth was predefined by random generation. The performance of the proposed method was evaluated in the accuracy of rotational and translational motion tracking. In the experiment, the velocities of the camera were set as ω^{c}=[0,0,0]^{T} rad/s and v^{c}=10×[sin(t), cos(t),0]^{T} m/s, and the velocities of the rigid body is fixed as ω^{a}=[1, sin(t), cos(t)]^{T} rad/s and v^{a}=[1,1,1]^{T} m/s.

Trajectories of estimated translational motion are plotted in FIG. 5. It is shown that the trajectory of estimated motion coincides with the ground-truth trajectory, showing the accuracy and effectiveness of the disclosed method in estimating both the direction and the magnitude of translational motion. Although the motion of the rigid body was set as unit velocities for three axes, arbitrary translational motion can be precisely recovered, provided that the motion does not have acceleration.

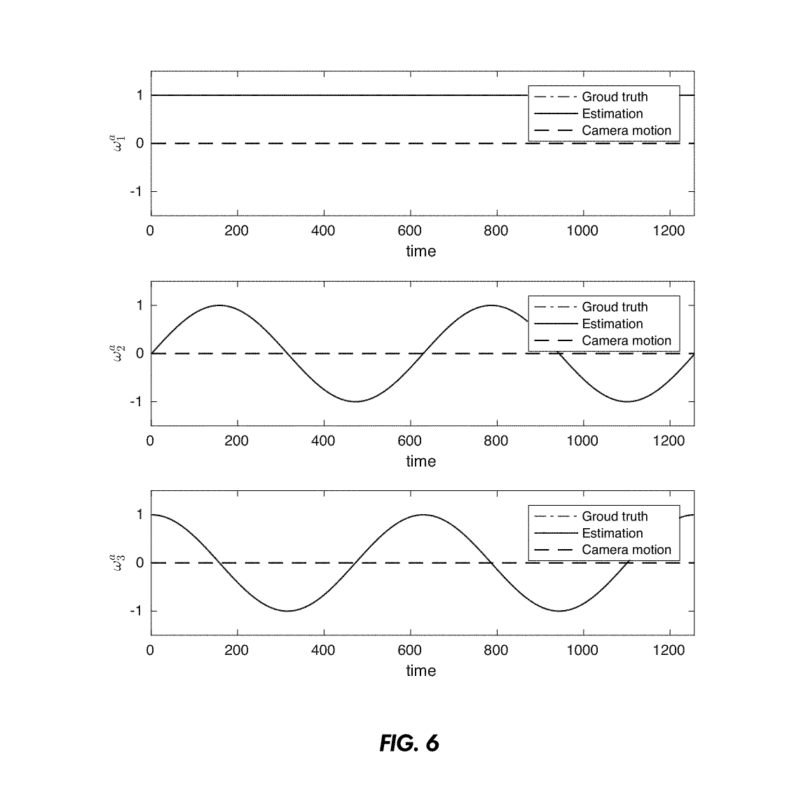

Trajectories of estimated rotational motion are shown in FIG. 6. In theory, rotational motion of a moving rigid body is recoverable regardless of the configuration of rigid-body motion and camera motion. In experiment, the rotational motion was also perfectly estimated with little errors caused by round-off in computation. The results reveal that the disclosed method can precisely estimate the motion of a moving rigid body, including translational and rotational velocities.

A random subset of optical-flow points is selected as hypothetical inliers, and the optimization is achieved on the subset through a fixed-point scheme. The initial estimations are computed from multiple measurements of optical flow by solving the bilinear constraint and the dynamics constraint. Starting from the initial points, estimations of relative rotational velocities, relative translational velocities, and relative distance are refined respectively. In each refinement cycle, a portion of optical-flow points are selected as candidate points in the manner of random sample consensus (RANSAC).

Updated relative translational velocities in the k+1 iteration are determined by optimizing a cost function with respect to the relative translational velocities. This is a least-square problem, and the solution to this problem is given by a homogeneous system of equations, which is solvable by computing the pseudo-inverse matrix of the coefficient of the homogeneous system.

Similarly, the updated relative rotational velocities can be estimated by another optimization problem with respect to the relative rotational velocities, which is a solvable homogeneous system of equations. The number of observations is chosen to be large enough to guarantee a good condition number of the coefficient matrix in practical applications.

With the computed relative translational and rotational velocities at the (k+1)-th epoch, the relative distances corresponding to feature-flow points are updated by a solvable homogeneous system of equations of unknown relative distances.

In each updating epoch, feature flow points are tested against criterion that have two conditions: the computed relative distances are greater than zero and matching errors of cost functions are within the predefined threshold. The condition guarantees that the recovered depth is greater than zero and the fitting errors are minimal. The optical-flow points satisfying the criterion are considered as part of the consensus set of the current motion estimation, while points violating the criterion are outliers. Two kinds of optical-flow points may appear to be outliers: pixels on another moving object and emerging views due to a viewpoint change. The local refinement repeats until a majority of optical-flow points are in the consensus set, and the motion estimation is considered sufficiently accurate.

With the estimated starting point, the suboptimal initial point is generally sharply concentrated around the globally optimization. The local fixed-point optimization improves measurement accuracy by suppressing the influence of noisy observations and outliers, even though the global optimization of motion estimation is not guaranteed using the iterative optimization.

Dynamics of the camera 10 and an observed object are described by a general discrete-time stochastic nonlinear system. The state is comprised of relative translational velocities up to a scale, translational acceleration of the camera, bias of translational acceleration of the camera, translational acceleration of the moving rigid body, bias of translational acceleration of the rigid body, and relative rotational velocities, and the scale of relative translational velocities. The observation variables of the system include estimated translational velocities, acceleration of the camera 10 measured by the IMU 12, and estimated rotational velocities, and the estimated velocity scale. The jerks of the acceleration of the camera 10 and the rigid body, the change of acceleration biases, angular acceleration, and the change of the velocity scale, are modeled as system noise. Acceleration biases are assumed to be stable but with minor unknown dynamics. Extended Kalman filter (EKF) or Unscented Kalman filter can be used to generate a smoothed trajectory based on the system model from instantaneous motion estimation.

The performance of motion estimation was also evaluated on a visual-inertial sensing unit. The sensing unit includes a video camera and an attached 10-axis synchronized inertial sensor that measures the dynamics of the camera. The model of the camera was Ximea MQ013CG-ON, which provides color images, auto balance, and USB 3.0 communication. The model of the inertial sensor was VectorNav VN-100, which has 3-axis accelerometers, 3-axis gyroscopes, 3-axis magnetometers, and a barometric pressure sensor. The high-speed 10-axis inertial sensor outputs real-time 3D orientation measurements over the complete 360 degrees of motion. The ground-truth global positions of the camera and the rigid body to track were obtained by an OptiTrack multi-camera system. The tracking system in the laboratory is comprised of six HD cameras mounted on the roof to cover the main working space, and multiple visual markers were installed on the camera and object for motion tracking.

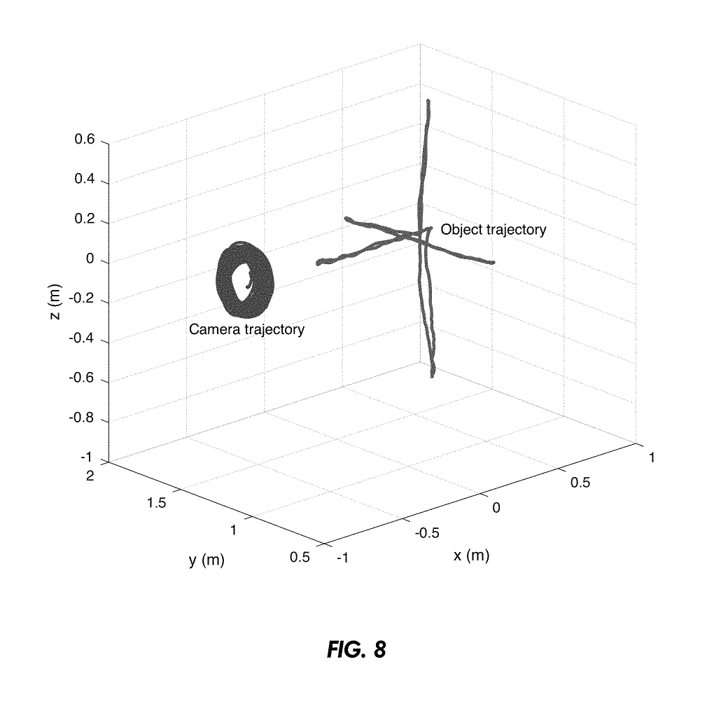

To evaluate the tracking performance of arbitrary object movements, the camera and the object were moved in a working space. During the process, video, camera acceleration, and global positions of the camera were recorded. The camera was moved around a line of sight to simulate the motion illustrated in FIG. 8, and the object was moved freely along different directions. Both the camera's and the object's motion are time variant. The absolute trajectories of the camera and the object are illustrated in the FIG. 8.

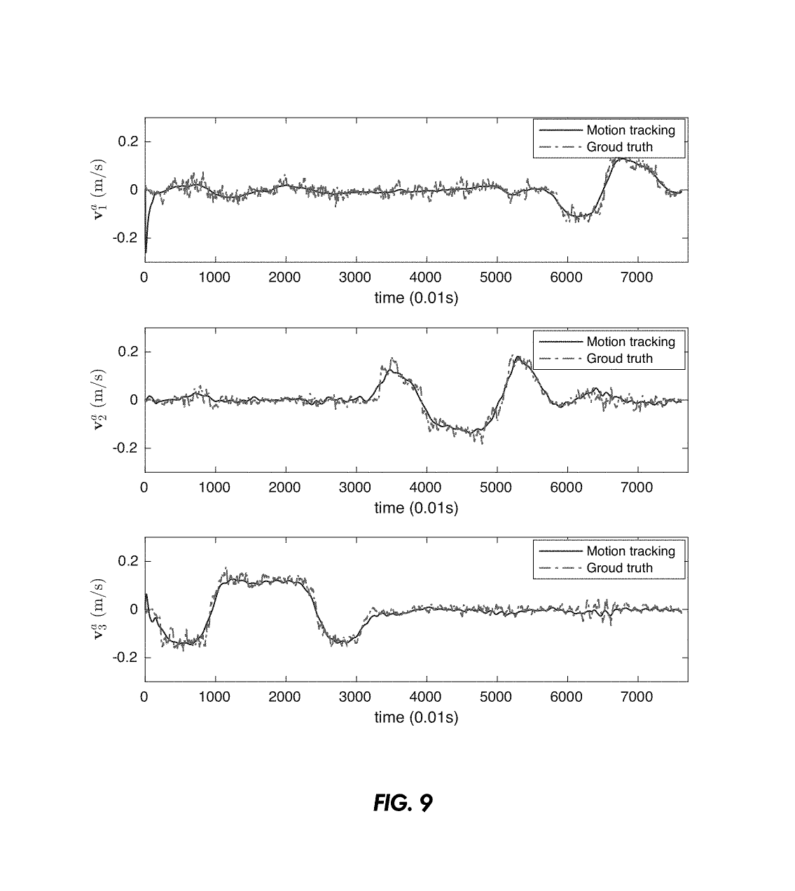

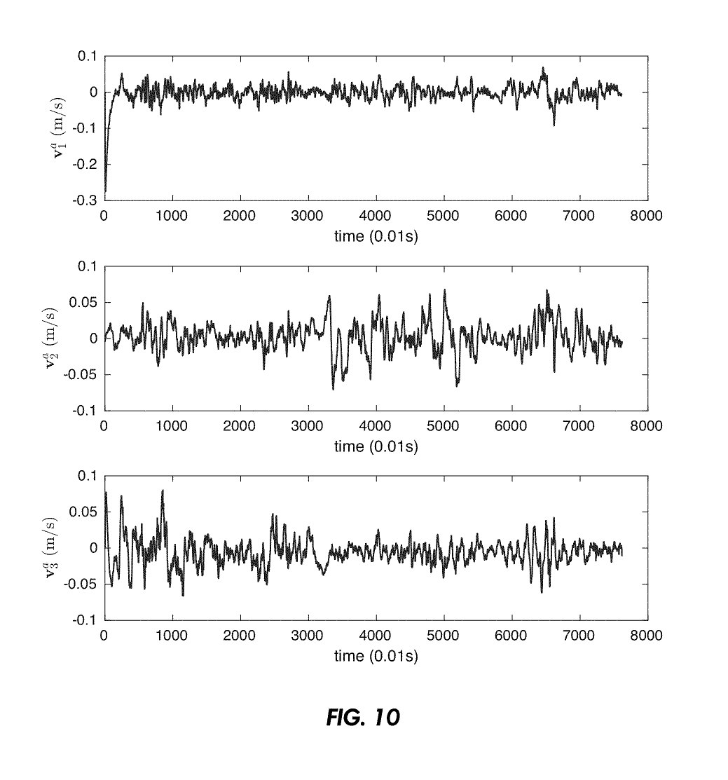

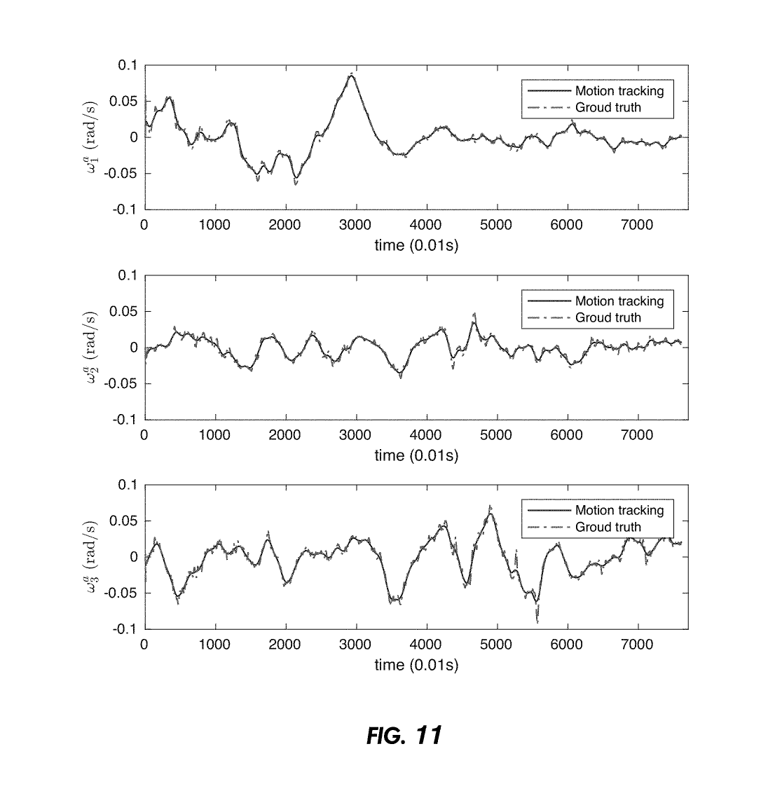

The estimation translational motion of the object and tracked motion by OptiTrack are compared in FIG. 9, and tracking errors are plotted in FIG. 10. The mean error is (−0.0024, 0.0024, 0.0059) and the standard deviation is (0.0244, 0.0197, 0.0180) for the movements along 3-axes. The estimation trajectory is smoother that the ground truth due to the extended Kalman filter in the motion model, which filtered out the jerk noise. At the beginning of the trajectory, there was a climbing time delay in the initialization, and after a short period, the estimation was able to track the ground truth without a stable-state error.

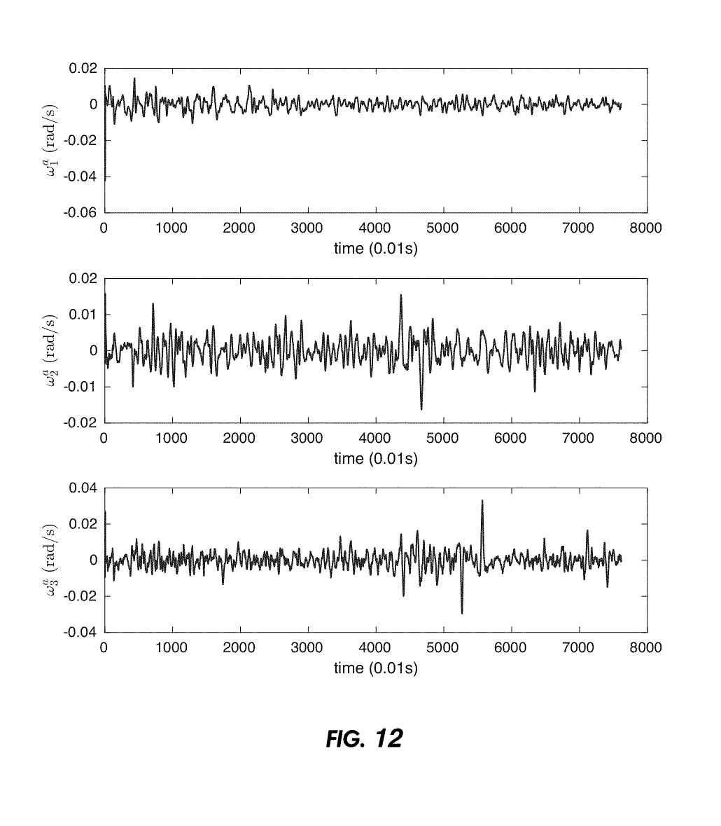

The estimation rotational motion of the object and tracked motion by OptiTrack are compared in FIG. 11, and the tracking errors are plotted in FIG. 12. The mean error is (0.0003, −0.0004, −0.0005) and the standard deviation is (0.0031, 0.0034, 0.0048) for the movements along the 3-axis. In general, the estimation accuracy of rotational motion is higher that that of translational motion.

The instantaneous estimation was noisy for translational and rotational velocities. Nonetheless, the continuous estimation was smooth thanks to the filtering process. There were high-frequency jerks in the camera's movements, and the jerks were reflected in the estimated motion of the object as well. Through motion filtering, the jerk noise and estimation vibration were suppressed, and the estimated motion trajectory coincided with the ground truth. In spite of measurement noise, the proposed motion estimation method can estimate and track the object's free-form motion.

There are three reasons that may attribute to the tracking errors in the experiment. The first reason is that the constant acceleration assumption on the environmental motion does not hold. The actual movement of the target was with time variant acceleration so that instantaneous estimations may become unstable and imprecise in this scenario. The second reason is the introduced noise in the inertial and visual observations, which may cause large computation errors especially for the region when the relative velocity is around zero. The third reason is that the jerk movement of the camera may cause spikes in the motion estimation. The inertia of the motion tracking model may be increased in order to smooth the motion trajectories.

The system and method of estimating relative motion using a visual-inertial sensor advantageously enable a visual sensor, such as a camera, to determine the velocity of an object within the view of the camera. For example, the system and method of the present disclosure may be implanted on a robotic arm or other like mechanism for aiding in tracking motion of an object relative to a robot to assist in manipulating an object. Additionally, the system and method of the present disclosure may be used on vehicles to alert of an impending collision or to otherwise track a translational velocity of an object near the vehicle.

The foregoing description of preferred embodiments of the present disclosure has been presented for purposes of illustration and description. The described preferred embodiments are not intended to be exhaustive or to limit the scope of the disclosure to the precise form(s) disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. A method of determining translational motion of a moving object within a field of view of a camera, the method comprising:
providing an imaging device oriented to capture a moving object within a field of view from a point of view of the device;
accelerating the central point of the imaging device around a line of sight;
processing visual data from the imaging device on a processing unit to determine a visual optical flow or feature flow in the field of view of the device;
measuring an acceleration of the camera around the line of sight; and
determining a translational velocity of a moving object within the field of view of the imaging device based on the determined visual optical flow of the field of view and measured acceleration of the point of view of the imaging device.

2. The method of claim 1, further comprising measuring the acceleration of the imaging device around the line of sight with an inertial measurement unit associated with the imaging device.

3. The method of claim 2, wherein the central point of the imaging device is accelerated on a turntable such that the imaging device is accelerated around the central point of the imaging device.

4. The method of claim 1, wherein the imaging device comprises a plurality of cameras located around the line of sight, and wherein the central point of the imaging device is accelerated by sequentially capturing an image on each of the plurality of cameras.

5. The method of claim 1, wherein a translation velocity of a fixed object in the field of view of the camera is assumed to be constant.

6. A method of determining translational motion of a moving object within a field of view of a camera, the method comprising:
determining a visual feature flow of a scene captured on a visual sensor applying a bilinear constraint to the visual feature flow captured on the visual sensor to determine a relative rotational velocity of the visual sensor;
measuring dynamics of the visual sensor with an inertial sensor associated with the visual sensor;
applying a dynamics constraint based on visual sensor dynamics measured with the inertial sensor, visual feature flow from the visual sensor, and the determined relative rotational velocity of the visual sensor;
determining a relative translational velocity of an object moving within a field of view of the visual sensor based on the applied dynamics constraint.

7. The method of claim 6, wherein the translational velocity of the object moving within the field of view of the visual sensor is assumed to be constant.

8. The method of claim 6, further comprising applying a filter to refine the determined relative translational velocity of the object, the filter comprising:
selecting a random subset of optical flow points captured by the visual sensor;
initially estimating the relative translational velocity, rotational velocity, and relative depth estimation of the random subset of optical flow points within the field of view based on feature flow and measured visual sensor dynamics; and
iteratively updating each of the estimated translational velocity, rotational velocity, and relative depth estimations.

9. The method of claim 8, further comprising applying a Kalman filter to the estimated velocities of the random subset of optical flow points captured by the visual sensor.

10. The method of claim 8, further comprising repeating the iterative updating of each of the estimated velocities until an accuracy of the estimated velocities is within a predetermined threshold.

11. The method of claim 8, further comprising selecting a random subset of optical flow points captured by the optical sensor until a majority of optical flow points of the field of view have been selected.

12. The method of claim 6, wherein the relative translational velocity is determined based on a relationship between feature flow, relative rotational velocity, relative translational velocity, a location of pixels within the field of view of the visual sensor, acceleration of the visual sensor, and scene depth.

13. A system for estimating a velocity of an object comprising:
a visual sensor for capturing image data including an object within a field of view;
an inertial measurement unit associated with the visual sensor for measuring and outputting dynamics data of the visual sensor;
a processor in electronic communication with the visual sensor and the inertial measurement unit, the processor configured to
determine one of an optical visual flow and feature flow of the field view of the visual sensor;
determine an acceleration of the visual sensor around a line of sight based on dynamics data received from the inertial measurement unit;
estimate a translational velocity of the object within the field of view of the visual sensor based on the determined optical visual flow and feature flow and determined acceleration of the visual sensor around the line of sight of the visual sensor.

14. The system of claim 13, the visual sensor comprises an array of cameras concentrically located around a line of sight.

15. The system of claim 13, the visual sensor further including a turntable for accelerating the visual sensor around a line of sight.
